(19) United States
(12) Patent Application Publication
(10) Pub. No.: US 2020/0387355 A1
(43) Pub. Date: Dec. 10, 2020

(54) SYSTEMS AND METHODS FOR GENERATING PERMUTATION INVARIANT REPRESENTATIONS FOR GRAPH CONVOLUTIONAL NETWORKS

(71) Applicant: Insurance Services Office, Inc., Jersey City, NJ (US)

(72) Inventors: Radu Balan, Rockville, MD (US); Naveed Haghani, Fulton, MD (US); Maneesh Kumar Singh, Lawrenceville, NJ (US)

(73) Assignee: Insurance Services Office, Inc., Jersey City, NJ (US)

(21) Appl. No.: 16/893,704

(22) Filed: Jun. 5, 2020

Related U.S. Application Data
(60) Provisional application No. 62/857,947, filed on Jun. 6, 2019.

(51) Int. Cl. G06F 7/78; G06N 3/08; G06N 7/00; G06F 9/54

(52) U.S. Cl. CPC G06F 7/78; G06F 9/545; G06N 7/00; G06N 3/08

(57) ABSTRACT

A system for generating a permutation invariant representation of a graph is provided. The system assembles a dataset including a graph having a plurality of nodes and a number of features per node and generates a first matrix and a second matrix based on the plurality of nodes and the number of features per node. The system determines a set of node embeddings by a graph convolutional network based on the first matrix and the second matrix and determines a permutation invariant representation of the graph by a permutation invariant mapping based on the set of node embeddings. The system determines a universal attribute of the graph by a fully connected network based on the permutation invariant representation of the graph.

### RELATED APPLICATIONS

The present application claims the benefit of U.S. Provisional Application Ser. No. 62/857,947 filed on Jun. 6, 2019, the entire disclosure of which is expressly incorporated herein by reference.

### BACKGROUND

### Technical Field

The present disclosure relates generally to the field of neural network technology. Specifically, the present disclosure relates to systems and methods for generating permutation invariant representations for graph convolutional neural networks.

### Related Art

Graph convolutional networks (GCNs) are a form of machine learning which utilize a graph's adjacency matrix to learn a set of latent node embeddings. Permuting an order of the nodes in the adjacency leads to a different ordering of the rows in a latent embedding matrix. As such, any network that produces an estimate over these embeddings would not be consistent over permutations of the node ordering.

The foregoing problem results in prior art machine learning systems needing to learn all possible permutations of every graph in a training set. Accordingly, such a requirement necessitates additional processing time, memory, and computational complexity. Therefore, there is a need for computer systems and methods which can generate mapping such that any node ordering of a particular graph provides an identical result, thereby improving an ability of computer systems to more efficiently process data in a GCN. These and other needs are addressed by the computer systems and methods of the present disclosure.

### SUMMARY

The present disclosure relates to systems and methods for generating permutation invariant representations for graph convolutional neural networks. Specifically, the system includes one or more nodes having one or more features, a graph convolutional network (GCN), a permutation invariant mapping (PIM) Engine, and a fully connected network. The system generates a first matrix and a second matrix using the nodes and features. The first matrix and the second matrix are processed by the GCN and the GCN generates a set of node embeddings based on the first matrix and the second matrix. The set of node embeddings are processed by the PIM engine, where the PIM engine generates permutation data, such as a permutation invariant representation of a graph. To generate the permutation data, the PIM engine utilizes an ordering approach or a kernel approach. The permutation data is then processed by a fully connected network, which generates output data.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating latent embeddings without mapping as used by prior art systems, and latent embeddings with mapping as generated by the system of the present disclosure;

FIG. 2 is a diagram illustrating the system of the present disclosure;

FIG. 3 is a flowchart illustrating overall processing steps carried out by the system of the present disclosure;

FIG. 4 is a flowchart illustrating processing steps carried out by the system of the present disclosure for performing an ordering approach;

FIG. 5 is a diagram illustrating an illustrative matrix of a set of node embeddings generated by the ordering approach of the present disclosure, as described in FIG. 4;

FIG. 6 is a flowchart illustrating the processing steps carried out by the system of the present disclosure to perform a kernel approach;

FIG. 7 is a diagram illustrating an illustrative matrix of a set of node embeddings generated by the kernel approach of the present disclosure, as described in FIG. 6;

FIG. 8 is a graph showing a mean absolute error of testing data over training epochs;

FIG. 9 is a graph showing a mean absolute error with no permutation invariant mapping; and

FIG. 10 is a diagram illustrating hardware and software components capable of being utilized to implement the system of the present disclosure.

### DETAILED DESCRIPTION

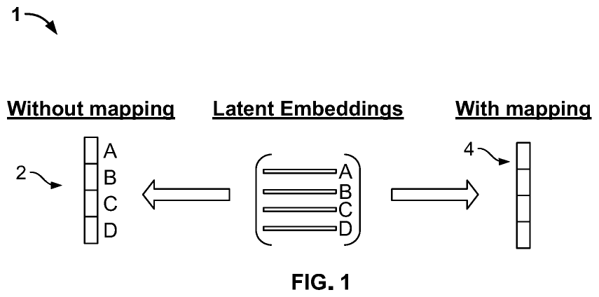

The present disclosure relates to computer systems and methods for generating permutation invariant representations for graph convolutional neural networks, as described in detail below in connection with FIGS. 1-10. In particular, the system processes a set of node embeddings generated by a graph convolutional network and generates an embedding for a graph G (with n nodes and r features per node) that is invariant to any permutation of the node offering. As such, rather than requiring a machine learning system to learn all possible permutations of every graph in a training set, the system of the present disclosure employs a permutation invariant mapping such that any node ordering of a particular graph provides an identical result.

By way of background, an embedding is a relatively low-dimensional space into which a system can translate high-dimensional vectors. Embeddings make it easier to perform machine learning on large inputs, such as sparse vectors representing words. Generally, the embeddings are flattened in preparation for applying a deep network (a class of machine learning which uses non-linear processing units' multiple layers for feature transformation and extraction). FIG. 1 is a diagram 1 illustrating latent embeddings without mapping 2 (as used by prior art systems) and latent embeddings with mapping 4 (as generated by the system of the present disclosure). Without the mapping performed by the system of the present disclosure, the order of flattened data (embeddings) would depend on the node ordering. However, using the novel system of the present disclosure, the flattened data is generated regardless of node ordering.

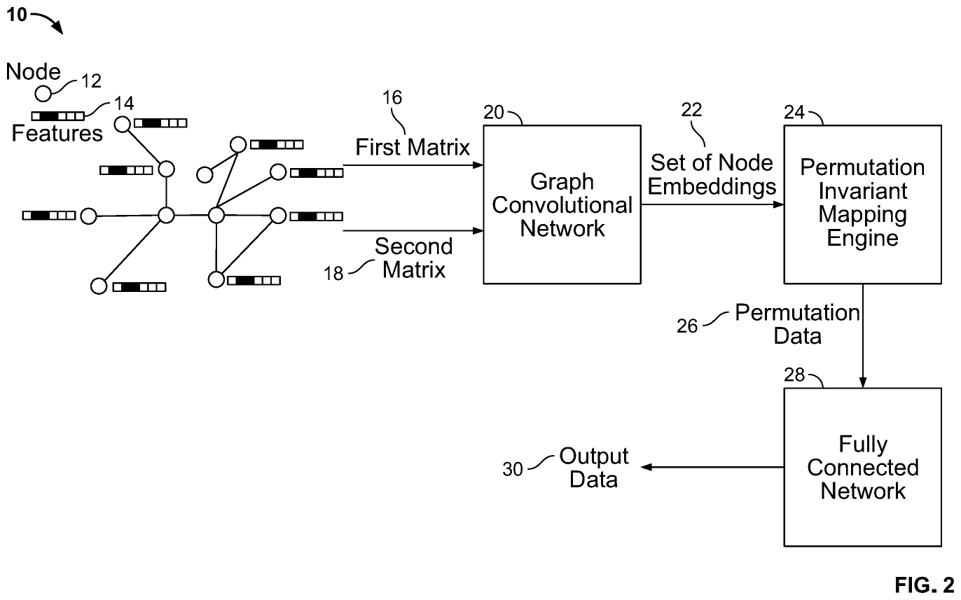

FIG. 2 is a diagram illustrating the system of the present disclosure, indicated generally at 10. The system 10 includes one or more nodes 12, one or more features 14 per node 12, a graph convolutional network (GCN) 20, a permutation invariant mapping (PIM) engine 24, and a fully connected network 28. The system 10 generates a first matrix 16 and a second matrix 18 utilizing the nodes 12 and features 14. The first matrix 16 and the second matrix 18 are received as inputs by the GCN 20. The GCN 20 then generates a set of node embeddings 22.

The set of node embeddings 22 are received as inputs by the PIM engine 24. The PIM engine 24 generates permutation data 26, such as a permutation invariant representation of the graph (G). To generate the permutation data 26, the PIM engine 24 can use an ordering approach or a kernel approach. Both will be explained in greater detail below. The permutation data 26 is then received as an input by the fully connected network 28. The fully connected network 28 can be any type of neural network, such as a convolutional neural network, a deep neural network, a recurrent neural network, a machine learning system, etc. The fully connected network 28 then generates the output data 30, which can be expressed as a final estimate \hat{p}.

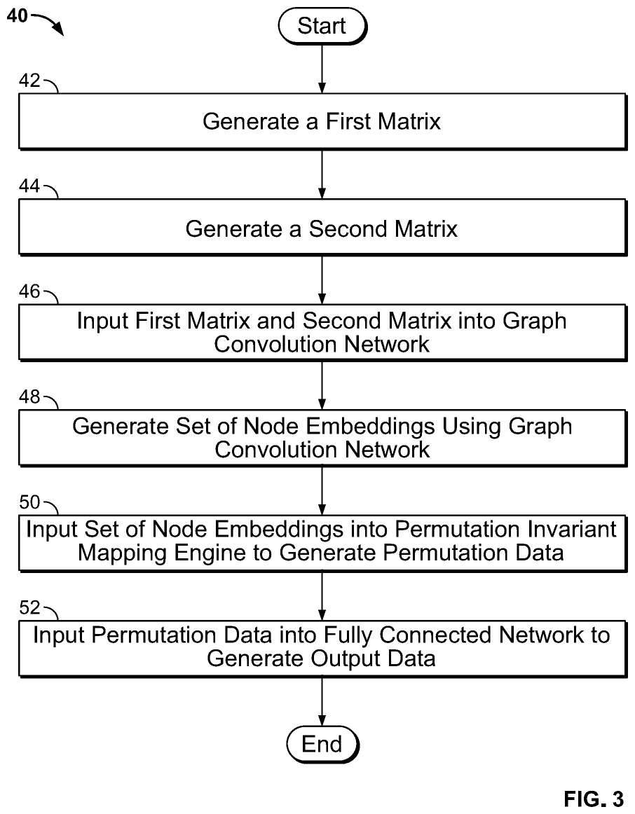

FIG. 3 is a flowchart 40 illustrating overall processing steps carried out by the system 10. In step 42, the system 10 generates the first matrix 16 using the nodes 12 and the features 14 as input data. By way of example, the first matrix 16 is an adjacency matrix (denoted as A∈W [symbol] ^{n×n}). In step 44, the system 10 generates the second matrix 18 using the nodes 12 and the features 14 as input data. By way of example, the second matrix is a feature matrix (denoted as X∈ [symbol] ^{n×n}). Those skilled in the art would understand that the system 10 can generate other types of matrixes from the nodes 12 and the features 14 to be received as input data by the GCN 20.

In step 46, the system 10 inputs the first matrix 16 and the second matrix 18 into the GCN 20. In step 48, the system 10 generates a set of node embeddings 22 using the GCN 20. By way of example, the set of node embeddings 22 can take the form of a latent feature matrix (denoted as Y∈ [symbol] ^{n×d}). However, those skilled in the art would understand that the GCN 20 can generate other types of matrixes that can be utilized by the system 10 of the present disclosure. To generate the latent feature matrix, a first layer can be denoted by H₁=σ(ÂXW₁) and subsequent layers can be denoted by Hᵢ₊₁=σ(ÂHᵢWᵢ₊₁). A permutation equivariant/covariant for any valid permutation matrix it is denoted as follows: if GCN(A, X)=Y, then GCN(πAπ^{T}, πX)=πY.

In step 50, the system inputs the set of node embeddings 22 into the PIM engine 24 and generates permutation data 26, which is invariant to row permutations of the set of node embeddings 22 (e.g., Y∈ [symbol] ^{n×d}). Specifically, the PIM engine 24 takes an equivalent relation ˜ on [symbol] ^{n×d} such that given V, V′∈ [symbol] ^{n×d}, V˜V′ if ∃π∈Sₙ s. t. V′=ηV. Next, the PIM engine 24 determines ϕ: [symbol] ^{n×d}→ [symbol] ^{m×D} such that the following is observed: (1) per mutation invariance; if V˜V′ then ϕ(V)=ϕ(V′); (2) injectivity modulo permutations; if ϕ(V)=ϕ(V′), then V˜V′; and (3) Lipschitz; ∥ϕ(V)−ϕ(V′)∥₂≤Lmin_{π∈S}_{ₙ} {∥V−πV′ν_{F}}. ϕ(⋅) produces matrix invariant to permutations of input if ϕ(Y)=Z then ϕ(πY)=Z. The PIM engine 24 further admits end to end permutation invariance using the logic of: if (ϕ°GCN)(A, X)=Z then (ϕ°GCN)(πAπ^{T},πX)=Z, where Z is a permutation invariant representation of graph G.

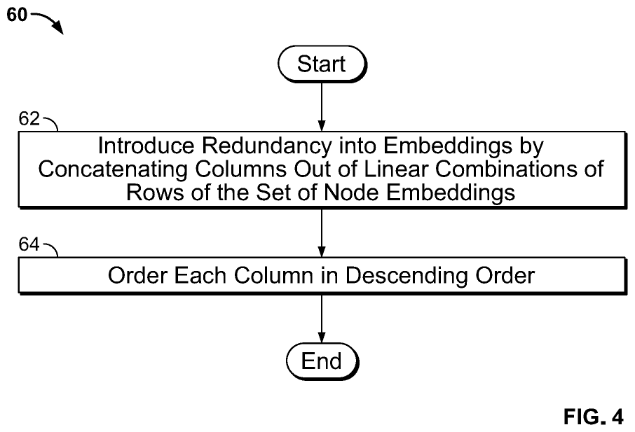

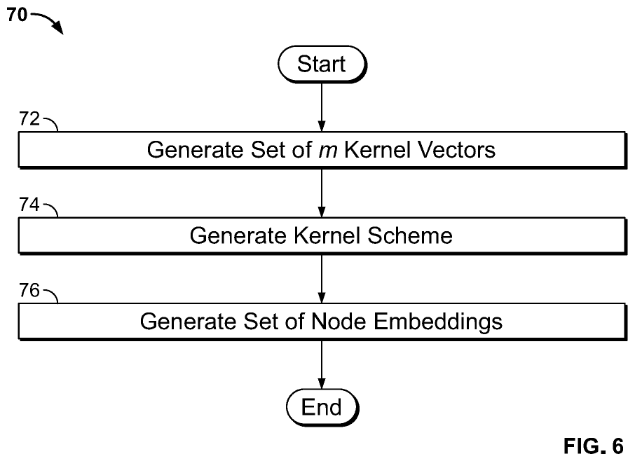

The PIM engine 24 then generates Z using, for example, the ordering approach 60 (as shown in FIG. 4) or the kernel approach 70 (as shown in FIG. 6). FIG. 4 is a flowchart illustrating the processing steps carried out by the system 10 to perform the ordering approach 60. In step 62, the system 10 introduces redundancy into the embeddings by concatenating additional columns out of linear combinations of rows of the set of node embeddings 22 by using the following Equation: Ŷ=Y×[I M], where I is an identity matrix and M is a linear transformation matrix. In step 64, the system 10 orders each column in a descending order using Equation 1, below, where Z⁽ⁱ⁾ is the i^{th} column of Z, and Ŷ⁽ⁱ⁾ is the i^{th} column of Ŷ:

Let λ: [symbol] ⁿ→ [symbol] ⁿ,λ(y)=(y_{π(k)})ₖ₌₁ⁿ, where y_{π(1)}≥ . . . ≥y_{π(n)}

Z⁽ⁱ⁾=λ(Ŷⁱ) Equation 1

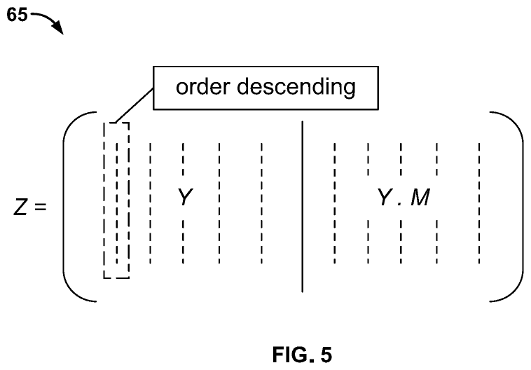

FIG. 5 is a diagram 65 illustrating an illustrative matrix of Z (permutation invariant representation of graph G) produced by the ordering approach 60. It is noted that the theorem for the ordering approach 60 includes taking the order mapping defined by the ordering approach 60 and represented by ϕ: [symbol] ^{n×d}/˜→ [symbol] ^{n×d+1} with M=1∈ [symbol] ^{n×1}, then ϕ is Lipschitz everywhere and injective for almost every V∈ [symbol] ^{n×d}/˜.

FIG. 6 is a flowchart illustrating processing steps carried out by the system 10 to perform the kernel approach 70. In step 72, the system 10 generates a set of m kernel vectors, which can be represented as follows: aᵢ∈ [symbol] ^{d}, for i=1, . . . , m. In step 74, the system 10 generates a kernel scheme, which as shown by Equation 2, below:

$$v \text{:} {ℝ}^{d} \times {ℝ}^{d} \to ℝ , v ( {a}_{i} , t ) = exp \{ - \frac{π {‖ {a}_{i} - t ‖}^{2}}{{σ}_{i}^{2}} \} \\ {σ}_{i} = {E}_{t} [ {‖ {a}_{i} - t ‖}^{2} ] \qquad Equation 2$$

In step 76, the system 10 generates a set of node embeddings (Z∈ [symbol] ^{m}), where y⁽ⁱ⁾ ∈ [symbol] ^{d} represents an i^{th} row of Y (transposed to a column vector), and where Zᵢ is expressed by Equation 3, below:

$${z}_{i} = {\sum }_{k = 1}^{n} v ( {a}_{i} , {y}^{( k )} ) , for i ∈ \{ 1 , … m \} \qquad Equation 3$$

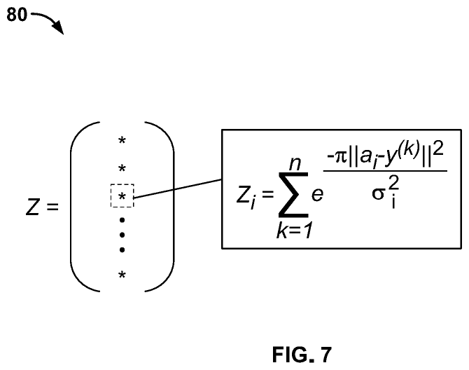

FIG. 7 a diagram 80 illustrating an illustrative matrix Z produced by the kernel approach 70, as associated with Equation 3, above.

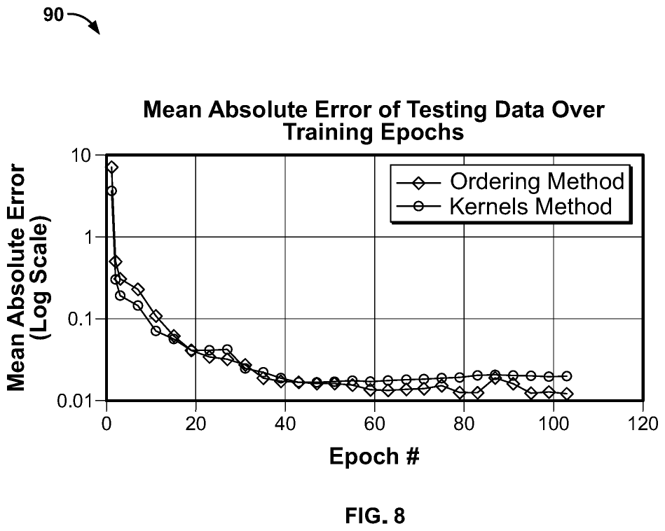

Testing and analysis of the above systems and methods will now be discussed in greater detail. The system 10 of the present disclosure was run on a QM9 dataset, which is comprised of one hundred thirty four thousand (134,000) chemical compounds along with thirteen computational derived quantum chemical properties for each compound. The system 10 performed regression over these values, where a norm of static polarization α (Bohr³) was observed. FIG. 8 is a graph 90 showing a mean absolute error of testing data over training epochs. The y-axis represents a mean absolute error (on a logarithmic scale) and the x-axis represents epoch numbers. Data points of the ordering approach 60 and the kernel approach 70 are displayed in the graph.

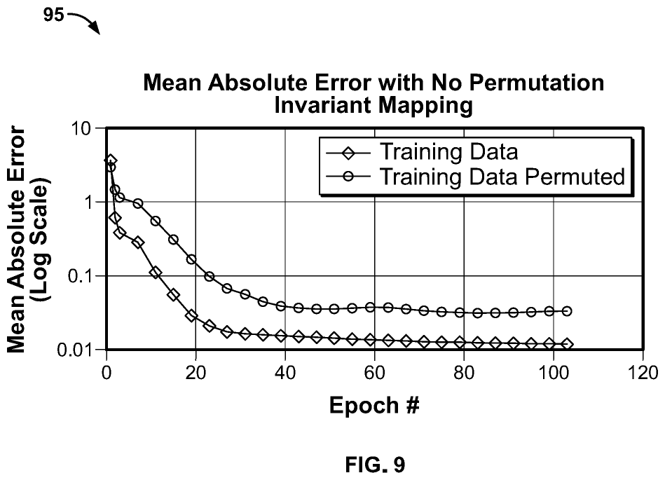

FIG. 9 is a graph 95 showing a mean absolute error with no permutation invariant mapping. The y-axis represents a mean absolute error (on a logarithmic scale) and the x-axis represents epoch numbers. Data points of un-permuted training data and permuted training data are displayed in the graph.

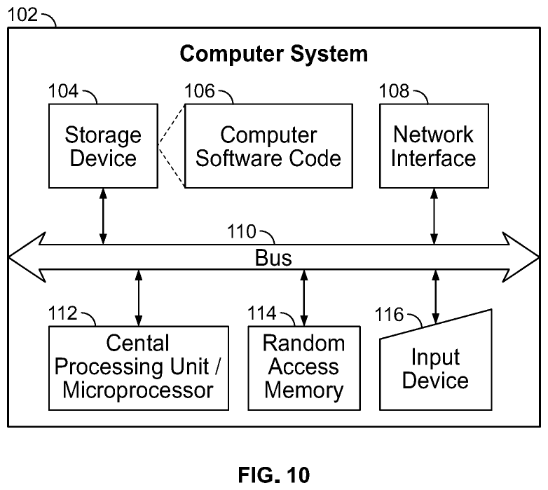

FIG. 10 is a diagram showing hardware and software components of a computer system 102 on which the system of the present disclosure can be implemented. The computer system 102 can include a storage device 104, computer software code 106, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 102 could be a networked computer system, a personal computer, a server, a smart phone, tablet computer etc. It is noted that the server 102 need not be a networked server, and indeed, could be a stand-alone computer system.

The functionality provided by the present disclosure could be provided by computer software code 106, which could be embodied as computer-readable program code stored on the storage device 104 and executed by the CPU 112 using any suitable, high or low level computing language, such as Python, Java, C, C++, C #, .NET, MATLAB, etc. The network interface 108 could include an Ethernet network interface device, a wireless network interface device, or any other suitable device which permits the server 102 to communicate via the network. The CPU 112 could include any suitable single-core or multiple-core microprocessor of any suitable architecture that is capable of implementing and running the computer software code 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed:

1. A machine learning system for generating a permutation invariant representation of a graph comprising:
a memory; and
a processor in communication with the memory, the processor:
receiving a dataset including a graph from the memory, the graph having a plurality of nodes and a number of features per node,
generating a first matrix and a second matrix based on the plurality of nodes and the number of features per node,
determining a set of node embeddings by a graph convolutional network based on the first matrix and the second matrix,
determining a permutation invariant representation of the graph by a permutation invariant mapping based on the set of node embeddings, and
determining an attribute of the graph by a fully connected network based on the permutation invariant representation of the graph.

2. The system of claim 1, wherein the first matrix is an adjacency matrix and the second matrix is a feature matrix.

3. The system of claim 1, wherein the set of node embeddings is a latent feature matrix and the permutation invariant representation of the graph is invariant to row permutations of the set of node embeddings.

4. The system of claim 1, wherein the permutation invariant mapping executes an ordering approach or a kernel approach to determine the permutation invariant representation of the graph.

5. The system of claim 4, wherein
the set of node embeddings is a latent feature matrix, and
the ordering approach introduces redundancy into the set of node embeddings by concatenating columns out of linear combinations of rows of the set of node embeddings and arranges each column in descending order.

6. The system of claim 1, wherein the fully connected network is a convolutional neural network, a deep neural network, a recurrent neural network or a machine learning system.

7. A method for generating a permutation invariant representation of a graph for a machine learning system, comprising the steps of:
receiving a dataset including a graph, the graph having a plurality of nodes and a number of features per node,
generating a first matrix and a second matrix based on the plurality of nodes and the number of features per node,
determining a set of node embeddings by a graph convolutional network based on the first matrix and the second matrix,
determining a permutation invariant representation of the graph by a permutation invariant mapping based on the set of node embeddings, and
determining an attribute of the graph by a fully connected network based on the permutation invariant representation of the graph.

8. The method of claim 7, further comprising executing an ordering approach or a kernel approach by the permutation invariant mapping based on the set of node embeddings.

9. The method of claim 8, wherein the executing an ordering approach comprises
introducing redundancy into the set of node embeddings by concatenating columns out of linear combinations of rows of the set of node embeddings, and
arranging each column in descending order.

10. The method of claim 7, wherein the first matrix is an adjacency matrix and the second matrix is a feature matrix.

11. The method of claim 7, wherein the set of node embeddings is a latent feature matrix and the permutation invariant representation of the graph is invariant to row permutations of the set of node embeddings.

12. The method of claim 7, wherein the fully connected network is a convolutional neural network, a deep neural network, a recurrent neural network or a machine learning system.

13. A non-transitory computer readable medium having instructions stored thereon for generating a permutation invariant representation of a graph for a machine learning system which, when executed by a processor, causes the processor to carry out the steps of:
receiving a dataset including a graph, the graph having a plurality of nodes and a number of features per node,
generating a first matrix and a second matrix based on the plurality of nodes and the number of features per node,
determining a set of node embeddings by a graph convolutional network based on the first matrix and the second matrix,
determining a permutation invariant representation of the graph by a permutation invariant mapping based on the set of node embeddings, and
determining an attribute of the graph by a fully connected network based on the permutation invariant representation of the graph.

14. The non-transitory computer readable medium of claim 13, the processor further carrying out the steps of:
executing an ordering approach or a kernel approach by the permutation invariant mapping based on the set of node embeddings.

15. The non-transitory computer readable medium of claim 14, wherein the executing the ordering approach comprises
introducing redundancy into the set of node embeddings by concatenating columns out of linear combinations of rows of the set of node embeddings, and
arranging each column in descending order.

16. The non-transitory computer readable medium of claim 13, wherein the first matrix is an adjacency matrix and the second matrix is a feature matrix.

17. The non-transitory computer readable medium of claim 13, wherein the set of node embeddings is a latent feature matrix and the permutation invariant representation of the graph is invariant to row permutations of the set of node embeddings.

18. The non-transitory computer readable medium of claim 13, wherein the fully connected network is a convolutional neural network, a deep neural network, a recurrent neural network or a machine learning system.
